(19) United States
(12) Patent Application Publication
(10) Pub. No.: US 2004/0190697 A1
(43) Pub. Date: Sep. 30, 2004

(54) Privacy 4

(76) Inventors: Ruy Lee, Arcadia, CA (US); Siu Lee, Arcadia, CA (US); Max Lee, Arcadia, CA (US); Jason Lee, Arcadia, CA (US)

Correspondence Address: Ruy Lee, 420 South Old Ranch Road, Arcadia, CA, 91007, US

(21) Appl. No.: 10/400,301

(22) Filed: Mar. 28, 2003

(51) Int. Cl. H04M 11/00; H04M 15/06; H04M 1/56

(52) U.S. Cl. 379/142.05; 379/93.02; 379/93.03

(57) ABSTRACT

A telecommunication device connect between the incoming phone line and the telephone set which permits or denies the rights of the receiver to receive the incoming phone call by the caller to dial the extension numbers if match the previous save numbers sets or not.

A device connect between the incoming phone line and the telephone set which permits or denies the rights of the receiver to receive the incoming phone call by the caller to dial the extension numbers if match the previous save numbers sets or not.

The “Privacy 4” device has 4 digital numbers display screens, which allow the receiver to edit various sets of extension numbers from 0 to 9999 into the device memory chip also can record the incoming messages.

This Privacy 4 could be a separate device or fixed into telephone set. The telephone set may be included multiple functions such as, Privacy 4, Caller Identification Number, telephone record, etc.

### BACKGROUND OF THE INVENTION

Today our home and office receive lots commercial call and junk fax to disturb our daily life and business activities.

It wast our time and resource. Also may come up the cheating and crime to our loved. We need to stop it before it intrude to our home and office. This “Privacy 4” device stop it happen and drive it out from our home and office.

### BRIEF SUMMARY F the INVENTI N

This “Privacy 4” device could restricting the unwanted call and junk fax per the receiver preset the extention number set which the caller could not know unless the receiver pass the preset extention number set to the caller.

### DETAILED DESCRIPTION F THE INVENTI N

Extention number show window:: show preset extension number set by dial from number pad. It also show the caller dial in the extention number set.

Save:: allow the receiver to save the extension number set.

Remove:: allow the receiver to remove the previous save extension number set.

List:: allow the receiver to review the preset extension number sets.

Message:: will show the caller leave recorded message.

Play:: allow the receiver to play the save recorded message.

Erase:: allow the receiver to erase the recorded message.

Record:: allow the receiver to record the two way conversation.

Ring:: On/Off switch control the ring sound.

Extension#:: On/Off switch control the extension number function.

Volume:: Low/High switch control the sound volume.

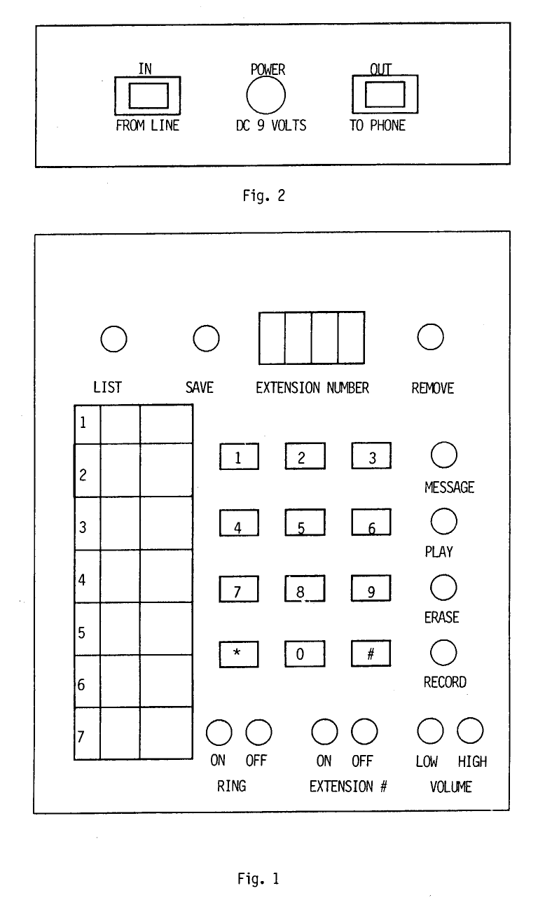

FIG. 1 is a top elevational view of a Privacy 4 showing my new invention device;

FIG. 2 is a rear elevational view thereof; The front plan view, the left plan view, the right plan view, the bottom plan views are flat.

### DRAWING DISCLOSURE

To the Commissioner of Patents and Trademarks:

Your petitioner, Ruy Lee, a citizen of the United States and a resident of Arcadia, Calif., prays that letters patent may be granted for the invention for a “Privacy 4”, as set forth in the following claim

The claimed “Privacy 4” is use to telephone access restricting device. A separate device connect between the incoming phone line and the telephone set which permits or denies the rights of the receiver to receive the incoming phone call by the caller to dial the extension numbers if match the save numbers sets or not. The device has 4 digital numbers display screens, which allow the receiver to edit various sets of extension numbers from 0 to 9999 into the device memory chip also can record the incoming messages.

This Privacy 4 could be a separate device or fixed into telephone set. The telephone set may be included multiple functions such as, Privacy 4, Caller Identification Number, telephone record, etc.

I claim:

1. The invention for a “Privacy 4” as shown.
